(19) United States
(12) Patent Application Publication
(10) Pub. No.: US 2021/0108002 A1
(43) Pub. Date: Apr. 15, 2021

(54) Purification Process For Capsular Polysaccharide

(71) Applicant: GLAXOSMITHKLINE BIOLOGICALS SA, Rixensart (BE)

(72) Inventors: Bass FALL, Siena (IT); Eva GRASSI, Siena (IT); Alessandro PIERO, Siena (IT)

(73) Assignee: GLAXOSMITHKLINE BIOLOGICALS SA, Rixensart (BE)

(21) Appl. No.: 16/463,434

(22) PCT Filed: Dec. 6, 2017
(86) PCT No.: PCT/IB2017/057705

§ 371 Date: May 23, 2019

Related U.S. Application Data
(60) Provisional application No. 62/430,602, filed on Dec. 6, 2016.

(51) Int. Cl. C08B 37/00; B01D 15/32

(52) U.S. Cl. CPC C08B 37/0003; B01D 15/325

(57) ABSTRACT

Purification methods suitable for purification of bacterial capsular polysaccharides from Streptococcus strains are provided.

### FIELD OF THE INVENTION

This invention is in the field of production of bacterial capsular polysaccharides, and relates to novel purification methods.

### BACKGROUND OF THE INVENTION

Capsular polysaccharides (CPS) are immunogens found on the surface of certain pathogenic bacteria involved in human and non-human disease. This feature has led to CPS being an important component in the design of vaccines. CPS have proved useful in eliciting immune responses especially when linked to carrier proteins (Ref 1).

Various large scale production methods for growing bacteria by fermentation are known, such as batch culture in complex medium, e.g., for production of capsular polysaccharides of Group B Streptococcus (S agalactiae), Staphylococcus aureus, Streptococcus pneumoniae (pneumococcus) and Haemophilus influenza; fed batch culture, e.g., for production of CPS of H. influenzae; and continuous culture, e.g., for production of CPS of Group B Streptococcus and Lactobacillus rhamnosus. (Refs. 2-7).

There is a need for effective methods that can be used to increase the relative percentage of CPS in a composition, by preferentially removing non-CPS components (contaminants) such as cellular proteins and nucleic acids. Such a method is useful in the production of bacterial capsular polysaccharides, including those from S. agalactiae, following culture and/or fermentation. Such methods are referred to herein as purification, or as a purification step.

### SUMMARY OF THE INVENTION

The present invention provides a method of removing protein from a solution, where the solution contains both bacterial capsular polysaccharide (CPS) and bacterial proteins. The method comprises a step of filtering the solution using chromatography (a chromatography step), in which the stationary chromatography phase is a particulate polymer resin (in the form of small, separate particles).

In one embodiment, the chromatography is carried out using column chromatography.

In one embodiment, the particulate polymer resin is in the form of spherical particles (one of skill in the art will understand that such particles will not be perfectly spherical and will vary to some degree in diameter and surface irregularities).

In a further embodiment, the polymer resin is made from polystyrene, polydivinylbenzene, copolymers of divinylbenzene and styrene, or cross-linked styrene and divinylbenzene.

In a further embodiment, the particulate polymer resin has one or more of the following characteristics: (a) the diameter of a representative sample of said spherical particles ranges from 300 μm to 1500 μm, 500 μm-750 μm, 560 μm-710 μm, 350-600 μm, or 350 μm-1200 μm; (b) non-ionic; (c) stable of a range of pH values from 0-14, 0-12, 1-14, 1-12, 2-14, or 2-12; (d) contains pores with an average diameter of approximately 100 Angstrom (Å), approximately 200 Å, approximately 350 Å, approximately 600 Å, approximately 700 Å, or approximately 1100 Å, (e) contains pores with a range of diameters, ranging from 200 Å-250 Å, 200 Å-300 Å, 300 Å-400 Å, or 300 Å-500 Å; and/or (f) contains macro-pores ranging in diameter from 10 microns to 200 microns.

In one embodiment, the polymer resin is in the form of spherical particles made of cross-linked styrene and divinylbenzene and having a range of diameters between 35-120 μm and a range of pore size between 200-300 Å.

In one embodiment, at least 50%, 60%, 70%, 80%, 85%, 87%, 90%, 91%, 92%, 93%, 94%, 95%, 96%, 97%, 98%, 99%, 99.2%, 99.5%, 99.9% or 100% of the protein is removed from the solution by the chromatography step.

In one embodiment, at least 50%, 60%, 70%, 80%, 85%, 87%, 90%, 91%, 92%, 93%, 94%, 95%, 96%, 97%, 98%, 99% or 100% of the CPS in the solution is retained in the eluate after chromatography.

In one embodiment, the step of filtering the solution using chromatography, in which the stationary chromatography phase is a particulate polymer resin, results in removal of at least 90% of the protein in the solution, while retaining at least 80%, 83%, 85%, 90%, 91%, 92%, 93%, 94%, or 95% of the CPS in the solution.

In one embodiment, the step of filtering the solution using chromatography has a minimal effect on polydispersity of the CPS. The polydispersity index is used as a measure of the broadness of a molecular weight distribution of a polymer, and is defined by: Polydispersity index=Mw/Mn. The larger the polydispersity index, the broader the molecular weight. A monodisperse polymer where all the chain lengths are equal (such as a protein) has an Mw/Mn=1. In one embodiment of the present invention, the difference in molecular weight between the starting material and the eluate is less than about 10%, less than about 8%, less than about 5%, less than about 3%, less than about 2%, or less than about 1%.

In one embodiment, the solution to be filtered comprises a buffer at about pH 8, optionally a Sodium Phosphate (NaPi) buffer.

In one embodiment, the step of filtering the solution using chromatography is started at a protein load density of from 0.5-4.0 mg Total Protein (TP) per milliliter of particulate resin.

In one embodiment, the step of filtering the solution using chromatography is started at a CPS load density of from 40-60 mg Total Polysaccharide per milliliter of particulate resin.

In one embodiment, the method does not include a step of cationic detergent treatment to precipitate the capsular polysaccharide. Particularly the method does not include a step of deproteinisation using phenol. Some polysaccharides are susceptible to hydrolysis. Therefore, when used for GBS particularly the method does not include a step of lowering the pH, for example to less than 4.5, to precipitate protein and nucleic acids.

In one embodiment, the chromatography step is preceded by alcohol precipitation of contaminating proteins and/or nucleic acids, and then diafiltration.

In one embodiment, the chromatography step is followed by re-N-acetylation of CPS, and diafiltration.

In one embodiment, the method of the invention comprises the following steps: (a) providing a composition containing bacterial capsular polysaccharide (CPS) and bacterial proteins; (b) contacting the composition with an alcohol solution, and removing any precipitate that forms; (c) maintaining the non-precipitated material from step (b) in solution and filtering the solution to remove smaller molecular weight compounds while retaining the capsular polysaccharide in solution; and (d) collecting the filtrate from step (c) and chromatographically removing protein contaminants from said filtrate, using a polymer resin stationary phase, to provide purified capsular polysaccharide. This method may further comprise a step (e) of re-N-acetylating the purified capsular polysaccharide, a step (f) of precipitating the purified capsular polysaccharide, and a step (g) of conjugating the capsular polysaccharide with a carrier protein.

In one embodiment, where the method of the invention comprises contacting the composition with an alcohol solution, to reach a concentration of alcohol sufficient to precipitate nucleic acid contaminants but to not precipitate the capsular polysaccharides. The alcohol solution may comprise ethanol, and optionally further comprise CaCl₂). In one embodiment, the alcohol solution is added to reach a concentration of between about 10% and about 50% ethanol, or to a concentration of about 30%.

In one embodiment of the present invention, the bacterial capsular polysaccharide is a Streptococcus agalactiae CPS. The Streptococcus agalactiae CPS may be selected from serotypes Ia, Ib, II, III, IV, V, VI, VII, VIII and IX, for example, Ia, Ib and III; Ia, Ib, II, III and V; Ia, Ib, II, III, IV and V; Ia, Ib, II, III, IV, V and VI.

The amount of protein in a solution, such as in a chromatographic eluate obtained using a method of the present invention, may be measured by any suitable method, such as the BCA assay as described herein. The amount of CPS in a solution, such as in a chromatographic eluate obtained using a method of the present invention, may be measured by any suitable method, such as methods described herein.

In particular, the inventors have found that chromatographic separation of CPS from contaminants, particularly protein contaminants, can effectively be carried out using a resin as the stationary chromatography phase. In one aspect, the chromatography is column chromatography. Suitable resins for use in the present invention include polymer resins made from polystyrene, polydivinylbenzene, copolymers of divinylbenzene and styrene, or cross-linked styrene and divinylbenzene. The resin is suitable in the form of a sphere or bead, where the particle diameter (in a representative sample of the resin beads) ranges from 300 μm to 1500 μm, from 500 μm to 750 μm, from 560 μm to 710 μm, from 350 to 600 μm, or from 350 μm to 1200 μm.

The chromatographic step may be combined with one or more of the steps described herein, including alcoholic precipitation and cation exchange, diafiltration, re-N-acetylation, and conjugation to a carrier molecule. The invention specifically envisages a method for purifying bacterial capsular polysaccharide, such as from Streptococcus agalactiae, comprising a step of chromatographic filtration using a resin material as the stationary phase, wherein the method does not include (either prior to or following chromatography) a step of cationic detergent treatment to precipitate the capsular polysaccharide followed by a step of re-solubilization of the capsular polysaccharide.

The invention further provides methods for purifying capsular polysaccharides (CPS) on a manufacturing scale. The preferred species of Streptococcus is Streptococcus agalactiae, also referred to as Lancefield's Group B Streptococcus or GBS, in particular, strains 090, H36b, CBJ111, or M781.

In the present method the alcohol solution added to a concentration is sufficient to precipitate nucleic acid contaminants but not the capsular polysaccharide. In preferred embodiments, the alcohol is ethanol preferably added to a concentration of between about 10% and about 50% ethanol, more preferably to a concentration of between about 30% ethanol. The alcohol solution may optionally include a cation, preferably a metal cation, more preferably a divalent cation, most preferably calcium.

### BRIEF DESCRIPTION THE FIGURES

FIG. 1 is a schematic representation of the linkage of Group B Streptococcus capsular polysaccharides (CPS) and the Group B carbohydrate molecule.

FIG. 2 shows the structure of the AMBERLITE™XAD resin bead; each bead is a conglomeration of microspheres.

FIG. 3A-3B show deformations of chromatographic peaks: (A) Tailing, when the profile rises sharply and quickly reaches the maximum point then descends more slowly towards the baseline) and (B) Fronting (when the profile rises slowly to the point of maximum and descends rapidly towards the baseline peak). Numbers are shown using a comma as the decimal mark.

FIG. 4 graphs protein removal percentages for various resins tested in chromatographic purification.

FIG. 5 graphs polysaccharide yield percentages (recovery %) for various resins tested in chromatographic purification.

FIG. 6 graphs percentage of protein removed under different load conditions. Load densities are indicated using a comma as the decimal mark.

FIG. 7 graphs polysaccharide yield percentages under different load conditions.

### DETAILED DESCRIPTION

Streptococcus agalactiae, also known as Group B strep (GBS), is the commonest cause of serious infection and meningitis in babies under 3 months old. GBS is usually passed from mother to baby during birth. The introduction of national recommended guidelines in several countries to screen pregnant women for GBS carriage, and the appropriate use of antibiotics during delivery significantly reduced disease occurring within the first hours of life (early-onset disease, EOD), but it has had no significant effect on late-onset disease (LOD) and is not feasible in certain countries. Research into vaccines against GBS is ongoing.

There is a need for effective methods that can be used to purify bacterial polysaccharides, such as from S. agalactiae, following culture and/or fermentation. The approach exemplified in WO 2007/052168 is based on the method described in WO 2006/082527, which includes (a) an extraction step to extract polysaccharide from a fermentation biomass, (b) an alcoholic precipitation step to reduce contaminating nucleic acids and proteins by precipitation, (c) a filtration step, such as diafiltration, to remove the resulting precipitate, (d) a polysaccharide precipitation step in which a cationic detergent treatment is used to precipitate polysaccharide, and (e) a polysaccharide re-solubilization step.

Treating a mixture of GBS capsular polysaccharide and group-specific polysaccharide with a cationic detergent leads to preferential precipitation of the capsular polysaccharide, reducing contamination by the group-specific polysaccharide. Detergents for use in the precipitation of soluble polysaccharides include tetrabutylammonia and cetyltrimethylammonia salts (e.g., the bromide salts) (Ref. 14). Other detergents include hexadimethrine bromide and myristyltrimethylammonia salts.

When a detergent precipitation step is used, the polysaccharide (typically in the form of a complex with the cationic detergent) can be re-solubilized, either in aqueous medium or in alcoholic medium. The re-solubilized material is purified relative to the pre-precipitation suspension.

However, the subsequent separation of the precipitate from the supernatant (e.g. by centrifugation) and re-solubilization of CPS is laborious and may result in loss of capsular polysaccharide, thereby reducing yield. The efficiency of the cationic detergent treatment may also be dependent on the initial purity (relative presence) of the capsular polysaccharide composition being processed. The lower the initial purity of the capsular polysaccharide, the less efficient the cationic detergent treatment may be, further limiting yield.

WO2009081276 (PCT/IB2008/003729) describes a method for purifying a capsular polysaccharide in which a protein adherent filter is used to separate capsular polysaccharides from contaminants. The protein adherent filtration step is used in place of precipitation using cationic detergent treatment (such as described in WO 2007/052168 and WO 2006/082527). Avoidance of the precipitation of the capsular polysaccharide at this stage of the purification process means there is no need to separate the precipitate from the supernatant, or resolubilize the CPS. The adherent filters may contain activated carbon immobilized in a matrix. Examples of suitable filter units include carbon cartridges from Cuno Inc. (Meriden, USA), such as ZETACARBON filters. These carbon filters comprise a cellulose matrix into which activated carbon powder is entrapped and resin-bonded in place.

The present invention provides an improved process of CPS purification which utilizes a chromatographic resin filtration step, replacing the need for precipitation by cationic detergent treatment or filtration using a carbon filter. The present process provides improved CPS yield compared to that obtained using carbon filtration. Additionally, the difference between the molecular weight distribution of CPS in the starting material and in the eluate is reduced, compared to that seen using a carbon filter. More particularly, the difference between the molecular weight distribution of CPS in the starting material and in the eluate is less than 10%, less than 5%, less than 4%, less than 3%, less than 2% or less than 1%. Molecular weight is preferably measured in Daltons, for example, Kilo Daltons (KDa). Thus, the processes of the present invention do not include either a step of cationic detergent treatment or filtration using a carbon filter.

### Process Overview

The production by fermentation of bacterial CPS, and the initial recovery of CPS-containing material from the fermentation vessel, provides the raw material for CPS purification. Such starting material may be a pellet or cellular paste obtained (e.g., by centrifugation) from a fermentation biomass. Alternatively, the material may be the supernatant from a centrifuged bacterial culture, as during bacterial growth in culture a small amount of capsular polysaccharide is generally released into the culture medium.

The method of the invention may include one or more of the following steps.

### (a) Extraction

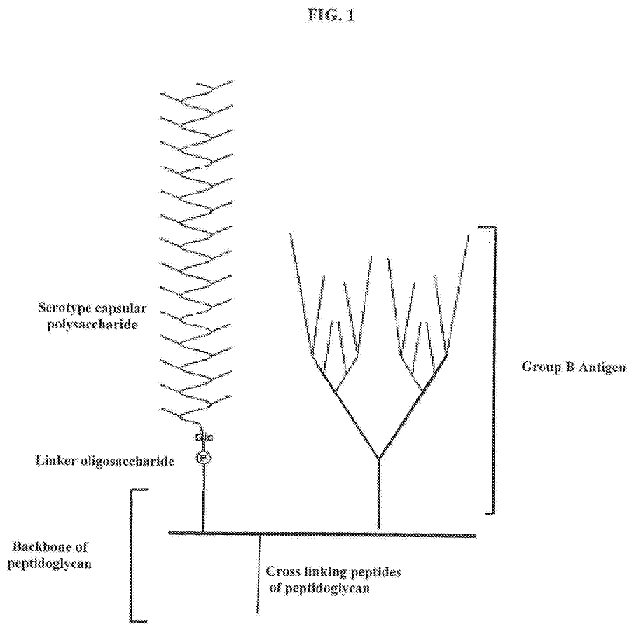

A first extraction step may be used to release the CPS from the bacteria (or from material containing the bacterial peptidoglycan, see FIG. 1). Methods for preparing capsular polysaccharides from bacteria are known in the art, e.g., see references 8-11. CPS can be released from bacteria by various methods, including chemical, physical or enzymatic treatment.

A typical chemical treatment is base extraction (Ref 12) (e.g., using sodium hydroxide), which can cleave the phosphodiester linkage between the capsular polysaccharide and the peptidoglycan backbone. As base treatment de-N-acetylates the capsular polysaccharide, however, later re-N-acetylation may be necessary.

Re-N-acetylation may be utilized with any method of preparing bacterial CPS, where that method de-N-acetylates the capsular polysaccharide.

A typical enzymatic treatment involves the use of both mutanolysin and β-N-acetylglucosaminidase (Ref 13). These act on the bacterial peptidoglycan to release the capsular polysaccharide for use with the purification method of the invention, but also lead to release of the group-specific carbohydrate antigen. An alternative enzymatic treatment involves treatment with a type II phosphodiesterase (PDE2). PDE2 enzymes can cleave the same phosphates as sodium hydroxide (see above) and can release the capsular polysaccharide without cleaving the group-specific carbohydrate antigen and without de-N-acetylating the capsular polysaccharide, thereby simplifying downstream steps. PDE2 enzymes are therefore a preferred option for preparing capsular polysaccharides. De-N-acetylated capsular polysaccharide can be obtained by base extraction as described in U.S. Pat. No. 6,248,570 (Ref 12).

### (b) Alcoholic Precipitation and Cation Exchange

Compositions of bacterial capsular polysaccharides initially obtained after culture (e.g., by extraction) will generally be impure, contaminated with bacterial nucleic acids and proteins. These contaminants can be removed by sequential overnight treatments with RNAse, DNAse and protease. However, as a preferred alternative, rather than remove such contaminants enzymatically, a step of alcoholic precipitation can be used. If necessary (e.g., after base extraction), materials will usually be neutralized prior to the alcoholic precipitation step.

The alcohol used to precipitate contaminating nucleic acids and/or proteins is preferably a lower alcohol, such as methanol, ethanol, propan-1-ol, propan-2-ol, butan-1-ol, butan-2-ol, 2-methyl-propan-1-ol, 2-methyl-propan-2-ol, diols, etc. The selection of an appropriate alcohol can be tested empirically, without undue burden, but alcohols such as ethanol and isopropanol (propan-2-ol) are preferred, rather than alcohols such as phenol.

The alcohol is preferably added to the polysaccharide composition to give a final alcohol concentration of between 10% and 50% (e.g., around 30%). The most useful concentrations are those which achieve adequate precipitation of contaminants without also precipitating the polysaccharide. The optimum final alcohol concentration may depend on the bacterial serotype from which the polysaccharide is obtained, and can be determined by routine experiments without undue burden. Precipitation of polysaccharides with ethanol concentrations >50% has been observed.

The alcohol may be added in pure form or may be added in a form diluted with a miscible solvent (e.g., water). Preferred solvent mixtures are ethanol:water mixtures, with a preferred ratio of between around 70:30 and around 95:5 (e.g., 75:25, 80:20, 85:15, 90:10).

The polysaccharide may also be treated with an aqueous metal cation. Monovalent and divalent metal cations are preferred, and divalent cations are particularly preferred, such as Mg, Mn, Ca, etc., as they are more efficient at complex formation. Calcium ions are particularly useful, and so the alcohol mixture preferably includes soluble calcium ion. These may be added to a polysaccharide/alcohol mixture in the form of calcium salts, either added as a solid or in an aqueous form. The calcium ions are preferably provided by the use of calcium chloride.

The calcium ions are preferably present at a final concentration of between 10 and 500 mM (e.g., about 0.1 M). The optimum final Ca concentration may depend on the Streptococcus strain and serotype from which the polysaccharide is obtained, and can be determined by routine experiments without undue burden.

After alcoholic precipitation of contaminating proteins and/or nucleic acids, the capsular polysaccharide is left in solution. The precipitated material can be separated from the polysaccharide by any suitable means, such as by centrifugation. The supernatant can be subjected to microfiltration, such as dead-end filtration (perpendicular filtration), in order to remove particles that may clog filters in later steps (e.g., precipitated particles with a diameter greater than 0.22 μm). As an alternative to dead-end filtration, tangential microfiltration can be used. For example, tangential microfiltration using a 0.2 μm cellulose membrane may be used. The step of tangential microfiltration is typically followed by filtration using a 0.45/0.2 μm filter.

### (c) Diafiltration

A step of diafiltration may be used. For example, if a step of alcoholic precipitation and cation exchange is used (e.g., as described above), then a diafiltration step may be carried out after the precipitation of proteins and/or nucleic acids. Typically, a step of diafiltration is used after precipitation of proteins and/or nucleic acids, and before chromatographic separation using a resin matrix as the stationary phase.

The diafiltration step is particularly advantageous if base extraction or phosphodiesterase was used for release of the capsular polysaccharide from the bacteria or peptidoglycan, as the group specific spolyaccharide will also have been hydrolyzed, providing fragments smaller than the intact capsular polysaccharide. These small fragments can be removed by the diafiltration step.

Tangential flow diafiltration may be used. The filtration membrane should thus be one that allows passage of hydrolysis products of the group-specific antigen while retaining the capsular polysaccharide. A cut-off in the range 10 kDa-30 kDa is typical. Smaller cut-off sizes can be used, as the hydrolysis fragments of the group-specific antigen are generally around 1 kDa (5-mer, 8-mer and 11-mer polysaccharides), but the larger cut-off allows removal of other contaminants without leading to loss of the capsular polysaccharide.

At least five cycles of tangential flow diafiltration are usually performed, e.g., 5, 6, 7, 8, 9, 10, 11 or more. Typically, two courses of tangential flow diafiltration are performed. Between the first and second courses, the retentate of the first diafiltration course may be treated with an acetic acid/sodium acetate solution. The resultant suspension may be filtered to remove precipitate, e.g. using a 0.45 μm filter. The suspension may also, or in addition, be filtered using a 0.2 μm filter.

The diafiltration may be followed by further filtration using a 0.45/0.2 μm filter.

### (d) Chromatographic Filtration Using a Resin

A chromatography step is carried out using a resin matrix as the stationary stage. Suitably the chromatography is column chromatography. Suitable resins for use in the present invention include polymer resins made from polystyrene, polydivinylbenzene, copolymers of divinylbenzene and styrene, or cross-linked styrene and divinylbenzene. The resin is suitably in the form of a sphere or bead, where the particle diameter (in a representative sample of the resin beads) ranges from 300 μm to 1500 μm, from 500 μm to 750 μm, from 560 μm to 710 μm, from 350 to 600 μm, or from 350 μm to 1200 μm.

The eluate obtained from the chromatography step contains purified CPS, relative to the starting solution (i.e., the solution immediately prior to chromatography).

### (e) Re-N-Acetylation

A step of re-N-acetylation may be carried out, for example after a step of chromatographic filtration using a resin, or after any subsequent filtration steps. Re-N-acetylation may be advantageous if sialic acid residues in the GBS capsular polysaccharides have been de-N-acetylated by any previous step in the process, for example during treatment with a base. Controlled re-N-acetylation can conveniently be performed using a reagent such as acetic anhydride (CH₃CO)₂O, e.g. in 5% ammonium bicarbonate (Wessels et al. (1989) Infect Immun 57:1089-94).

A further step of diafiltration may be carried out, for example after re-N-acetylation following chromatographic filtration using a resin. The diafiltration may be followed by further filtration using a 0.45/0.2 μm filter.

Bacterial capsular polysaccharide produced by the present method may further be prepared as a dried powder, ready for conjugation.

### Conjugate Preparation

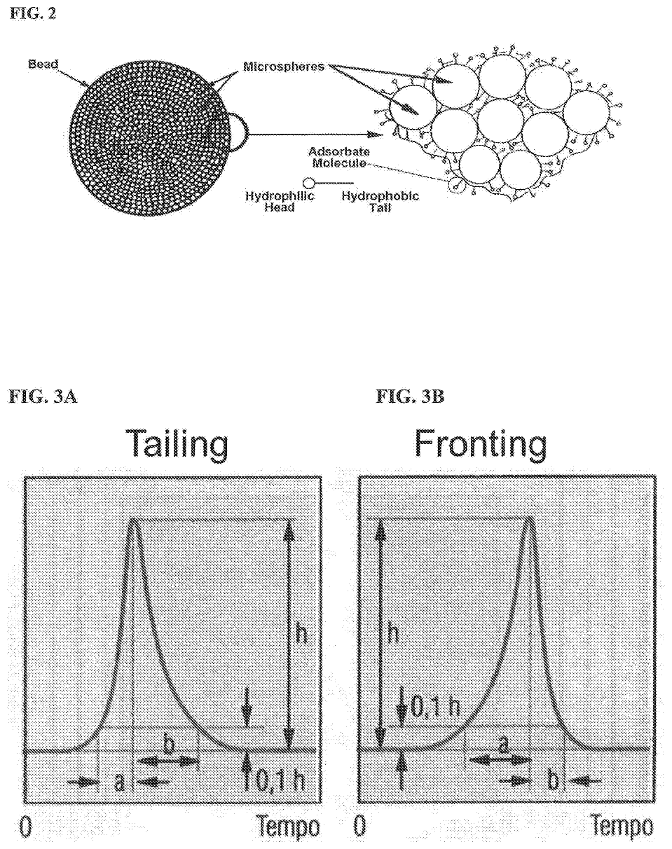

Following purification, the CPS may be conjugated to a carrier molecule, such as a protein. The invention therefore may further comprise steps of purifying CPS and conjugating the capsular polysaccharide to a carrier protein, to give a protein-saccharide conjugate (see FIGS. 1-2). The conjugated CPS may then be formulated into an immunogenic composition, such as a vaccine.

Purified capsular polysaccharides obtained by the present invention may be conjugated to carrier protein(s). In general, covalent conjugation of polysaccharides to carriers enhances the immunogenicity of polysaccharides as it converts them from T-independent antigens to T-dependent antigens, thus allowing priming for immunological memory. Conjugation is particularly useful for pediatric vaccines (e.g., ref 15) and is a well-known technique (e.g., reviewed in refs. 16-24)

Known carrier proteins include bacterial toxins or toxoids, such as diphtheria toxoid or tetanus toxoid, including the CRM197 mutant of diphtheria toxin. Other suitable carrier proteins include the N. meningitidis outer membrane protein (Ref 25), synthetic peptides (Refs. 26, 27), heat shock proteins (Refs. 28, 29), pertussis proteins (Refs. 30, 31), cytokines (Ref. 32), lymphokines (Ref 32), hormones (Ref 32), growth factors (Ref. 32), artificial proteins comprising multiple human CD4 T cell epitopes from various pathogen-derived antigens (Ref 33) such as N19 (Ref 34), protein D from H. influenzae (Ref. 35, 36), pneumococcal surface protein PspA (Ref 37), pneumolysin (Ref. 38), iron-uptake proteins (Ref. 39), toxin A or B from C. difficile (Ref. 40), antigenic GBS polypeptides such as BP-2a, spb1, GBS59, GBS80, GBS1523 or combinations thereof (see Ref. 41 & 79). Attachment to the carrier is preferably via a —NH2 group, e.g., in the side chain of a lysine residue in a carrier protein, or of an arginine residue. Where a saccharide has a free aldehyde group then this can react with an amine in the carrier to form a conjugate by reductive amination. Such a conjugate may be created using reductive amination involving an oxidized galactose in the saccharide (from which an aldehyde is formed) and an amine in the carrier or in the linker. Attachment may also be via a —SH group, e.g., in the side chain of a cysteine residue.

It is possible to use more than one carrier protein in an immunogenic composition, e.g., to reduce the risk of carrier suppression of immune response. Thus, in a multivalent composition, different carrier proteins can be used for different Streptococcus strains or serotypes, e.g., GBS serotype Ia polysaccharides might be conjugated to CRM197 while serotype Ib polysaccharides might be conjugated to tetanus toxoid. It is also possible to use more than one carrier protein for a particular polysaccharide antigen, e.g., serotype III polysaccharides might be in two groups, with some conjugated to CRM197 and others conjugated to tetanus toxoid.

A single carrier protein may carry more than one polysaccharide antigen (Refs. 42, 43). For example, a single carrier protein might have polysaccharides from serotypes Ia and Ib conjugated to it.

Conjugates with a polysaccharide:carrier ratio (w/w) of between excess carrier (e.g., 1:5) and excess polysaccharide (e.g., 5:1) are preferred. Ratios between 1:2 and 5:1 are preferred, as are ratios between 1:1.25 and 1:2.5. Ratios between 1:1 and 4:1 are also preferred. With longer polysaccharide chains, a weight excess of polysaccharide is typical. In general, the invention provides a conjugate, wherein the conjugate comprises a Streptococcus, preferably a S. agalactiae, capsular polysaccharide moiety joined to a carrier, wherein the weight ratio of polysaccharide:carrier is at least 2:1.

Compositions may include a small amount of free carrier. When a given carrier, such as a protein, is present in both free and conjugated form in a composition of the invention, the unconjugated form is preferably no more than 5% of the total amount of the carrier in the composition as a whole, and more preferably present at less than 2% by weight.

Any suitable conjugation reaction can be used, with any suitable linker where necessary.

The polysaccharide will typically be activated or functionalized prior to conjugation. Activation may involve, for example, cyanylating reagents such as CDAP (e.g., 1.-cyano-4-dimethylamino pyridinium tetrafluoroborate (Refs. 44, 45, etc.)). Other suitable techniques use carbodiimides, hydrazides, active esters, norborane, p-nitrobenzoic acid, N-hydroxysuccinimide, S—NHS, EDC, and TSTU (see also the introduction to reference 29).

Linkages via a linker group may be made using any known procedure, for example, the procedures described in references 46 and 47. One type of linkage involves reductive amination of the polysaccharide, coupling the resulting amino group with one end of an adipic acid linker group, and then coupling a protein to the other end of the adipic acid linker group (Refs. 27, 48, 49). Other linkers include B-propionamido (Ref 50), nitrophenyl-ethylamine (Ref 51), haloacyl halides (Ref. 52), glycosidic linkages (Ref. 53), 6-aminocaproic acid (Ref 54), ADH (Ref 55), C4 to C12 moieties (Ref 56), etc. As an alternative to using a linker, direct linkage can be used. Direct linkages to the protein may comprise oxidation of the polysaccharide followed by reductive amination with the protein, as described in, for example, references 57 and 58.

A process involving the introduction of amino groups into the saccharide (e.g., by replacing terminal ═O groups with —NH2) followed by derivatization with an adipic diester (e.g., adipic acid N-hydroxysuccinimido diester) and reaction with carrier protein is preferred. Another preferred reaction uses CDAP activation with a protein D carrier.

After conjugation, free and conjugated polysaccharides can be separated. There are many suitable methods, including hydrophobic chromatography, tangential ultrafiltration, diafiltration, etc. (see also refs. 59 & 60).

Where the composition of the invention includes a depolymerized oligosaccharide, it is preferred that depolymerization precedes conjugation, e.g., occurs before activation of the saccharide.

In one preferred conjugation method, a polysaccharide is reacted with adipic acid dihydrazide. For CPS from Streptococcus serogroup A, carbodiimide may also be added at this stage. After a reaction period, sodium cyanoborohydride is added. Derivatized polysaccharide can then be prepared, e.g., by ultrafiltration. The derivatized polysaccharide is then mixed with carrier protein (e.g., with a diphtheria toxoid), and carbodiimide is added. After a reaction period, the conjugate can be recovered.

### Additional Steps

As well as including the steps described above, methods of the invention may include further steps. For example, the methods may include a step of depolymerization of the capsular polysaccharides, after they are prepared from the bacteria but before conjugation. Depolymerization reduces the chain length of the polysaccharides and may not be suitable for CPS from GBS. For Streptococcus, especially GBS, longer polysaccharides tend to be more immunogenic than shorter ones (Ref. 61).

After conjugation, the level of unconjugated carrier protein may be measured. One way of making this measurement involves capillary electrophoresis (Ref 62) (e.g., in free solution), or micellar electrokinetic chromatography (Ref 63).

After conjugation, the level of unconjugated polysaccharide may be measured. One way of making this measurement involves High Performance Anion Exchange Chromatography with Pulsed Amperometric Detection (HPAEC-PAD).

After conjugation, a step of separating conjugated polysaccharide from unconjugated polysaccharide may be used. One way of separating these polysaccharides is to use a method that selectively precipitates one component. Selective precipitation of conjugated polysaccharide, e.g., by a deoxycholate treatment, is preferred, to leave unconjugated polysaccharide in solution.

After conjugation, a step of measuring the molecular size and/or molar mass of a conjugate may be carried out. In particular, distributions may be measured. One way of making these measurements involves Size Exclusion Chromatography with detection by Multiangle Light Scattering photometry and differential refractometry (SEC-MALS/RI) (Ref. 64).

### Conjugate Combinations

Purified CPS from Pneumococcus serogroups may be conjugated as described above, for any Pneumococcus serogroup. Pneumococcus serogroups used to prepare immunogenic conjugates include serogroups 1, 3, 4, 5, 6B, 7F, 9V, 14, 18C, 19F, and 23F. The individual conjugates can then be mixed, in order to provide a polyvalent mixture, such as a bivalent, trivalent, tetravalent, 5-valent, 6-valent, 7-valent, 11-valent or 13-valent mixture (e.g., to mix serogroups 1+3+4+5+6B+7F+9V+14+1 8C+19F+23F, 4+6B+9V+14+18C+19F+23F or 1+4+6B+9V+14+1 8C+19F+23F, etc.).

Purified CPS from GBS, may be conjugated as described above and conjugates may be prepared from one or more of serogroups Ia, Ib, II, III, IV, V, VI, VII, VIII, and IX. The individual conjugates can then be mixed, in order to provide a polyvalent mixture, such as a bivalent, trivalent, tetravalent, 5-valent, 6-valent, 7-valent, 8-valent, 9-valent or 10-valent mixture (e.g., to mix serogroups Ia+Ib+III, Ia+Ib+II+III+V, Ia+Ib+II+III+IV+V, Ia+Ib+II+III+IV+V+VI, etc.).

Different conjugates may be mixed by adding them individually to a buffered solution. A preferred solution is phosphate buffered physiological saline (final concentration 10 mM sodium phosphate). A preferred concentration of each conjugate (measured as polysaccharide) in the final mixture is between 1 and 20 μg/ml e.g., between 5 and 15 μg/ml, such as around 8 μg/ml. An optional aluminum salt adjuvant may be added at this stage (e.g., to give a final Al³⁺ concentration of between 0.4 and 0.5 mg/ml).

### Pharmaceutical Compositions

Conjugates prepared by methods of the invention can be combined with pharmaceutically acceptable carriers. Such carriers include any carrier that does not itself induce the production of antibodies harmful to the individual, such as a human individual, receiving the composition. Suitable carriers are typically large, slowly metabolized macromolecules such as proteins, polysaccharides, polylactic acids, polyglycolic acids, polymeric amino acids, amino acid copolymers, sucrose, trehalose, lactose, and lipid aggregates (such as oil droplets or liposomes). Such carriers are well known to those of ordinary skill in the art. The vaccines may also contain diluents, such as water, saline, glycerol, etc. Additionally, auxiliary substances, such as wetting or emulsifying agents, pH buffering substances, and the like, may be present. Sterile pyrogen-free, phosphate-buffered physiologic saline is a typical carrier. A thorough discussion of pharmaceutically acceptable excipients is available in reference 65.

Compositions may include an antimicrobial, particularly if packaged in a multiple dose format. Compositions may comprise detergent, e.g., a polysorbate, such as TWEEN™ 80. Detergents are generally present at low levels, (e.g., >0.01%).

Compositions may include sodium salts (e.g., sodium chloride) to give tonicity. A concentration of 10±2 mg/ml NaCl is typical. Compositions will generally include a buffer. A phosphate buffer is typical.

Compositions may comprise a sugar alcohol (e.g., mannitol) or a disaccharide (e.g., sucrose or trehalose) e.g., at around 15-30 mg/ml (e.g., 25 mg/ml), particularly if they are to be lyophilized or if they include material which has been reconstituted from lyophilized material. The pH of a composition for lyophilization may be adjusted to around 6.1 prior to lyophilization.

Conjugates may be administered to subjects in conjunction with other immunoregulatory agents. In particular, compositions administered as vaccines to induce a protective, prophylactic, or therapeutic immune response may include a vaccine adjuvant. Adjuvants which may be used in compositions of the invention include, but are not limited to: mineral-containing compositions such as mineral salts, such as aluminum salts and calcium salts (or mixtures thereof; where an aluminum hydroxide and/or aluminum phosphate adjuvant is used, antigens are generally adsorbed to these salts); oil emulsion compositions, including squalene-water emulsions, such as MF59 (Ref. Chapter 10 of ref 66; see also ref 67) (5% Squalene, 0.5% TWEEN™ 80, and 0.5% SPAN™ 85 (sorbitan trioleate), formulated into submicron particles using a microfluidizer); complete Freund's adjuvant (CFA) and incomplete Freund's adjuvant (IFA); saponin formulations such as QS21 (saponins are a heterologous group of sterol glycosides and triterpenoid glycosides that are found in a range of plant species, including the Quillaia saponaria Molina tree); virosomes and virus-like particles (VLPs); bacterial or microbial derivatives such as non-toxic derivatives of enterobacterial lipopolysaccharide (LPS); immunostimulatory oligonucleotides.

Further suitable adjuvants include virosomes and Virus-like particles (VLPs), which generally contain one or more proteins from a virus optionally combined or formulated with a phospholipid (see, e.g., refs. 68-74); bacterial or microbial derivative adjuvants, such as Lipid A derivatives, immunostimulatory oligonucleotides, ADP-ribosylating toxins and detoxified derivatives thereof, non-toxic derivatives of LPS including monophosphoryl lipid A (MPL) and 3-O-deacylated MPL (3dMPL), aminoalkyl glucosaminide phosphate derivatives (e.g., RC-529, Ref 75-76), and OM-174 (refs 77-78).

Further suitable adjuvants include immunostimulatory oligonucleotides such as nucleotide sequences containing a CpG motif; bacterial ADP-ribosylating toxins and detoxified derivatives thereof; human immunomodulators such interleukins, interferons, macrophage colony stimulating factor, and tumor necrosis factor; imidazoquinolone compounds such as IMIQUAMOD™ and its homologues (e.g., RESIQUIMOD 3M™).

The invention may also comprise combinations of aspects of one or more of the adjuvants identified above.

### Compositions

Compositions of the present invention may be administered to any suitable subject in need of such administration, such as humans, non-human primates, livestock and companion animals. The immunogenic compositions may be sterile and/or pyrogen-free. Compositions may be isotonic with respect to the intended subject, e.g. humans.

Immunogenic compositions used as vaccines comprise an immunologically effective amount of antigen(s), as well as any other components, as needed and as tailored to the intended recipient. By immunologically effective amount, it is meant that the administration of that amount to an individual, such as a human individual, either in a single dose or as part of a series, is effective for treatment or prevention of infection or disease caused by the target pathogen. This amount varies depending upon the health and physical condition of the individual to be treated, age, the taxonomic group of individual to be treated (e.g., non-human primate, primate, etc.), the capacity of the individual's immune system to synthesize antibodies, the degree of protection desired, the formulation of the vaccine, the treating doctor's assessment of the medical situation, and other relevant factors. A typical quantity of each streptococcal conjugate in a vaccine composition for human use is between 1 μg and 20 μg per conjugate (measured as saccharide).

Thus the invention provides a method for preparing a pharmaceutical composition, comprising the steps of: (a) preparing a polysaccharide:carrier conjugate as described above; (b) mixing the conjugate with one or more pharmaceutically acceptable carriers.

The invention further provides a method for preparing a pharmaceutical product, comprising the steps of: (a) preparing a polysaccharide:carrier conjugate as described above; (b) admixing the conjugate with one or more pharmaceutically acceptable carriers; and (c) packaging the conjugate/carrier mixture into a container, such as a vial or a syringe, to give a pharmaceutical product.

The conjugation method and the admixing step can be performed at different times by different people in different places (e.g., in different facilities or countries).

### Streptococcus

The term “Streptococcus” refers to bacteria that may be selected from S. agalactiae (GBS), S. pyogenes (Group A Strep, GAS), S. pneumoniae (pneumococcus) and S. mutans. The streptococcus may alternatively be S. thermophilus or S. lactis. Preferably the Streptococcus is GBS. If the Streptococcus used is GBS, then preferably the serotype selected is Ia, Ib, II, III, IV, or V. Preferably the strains of GBS used are 090 (1a), 7357 (1b), H36b (1b), DK21 (2), M781 (3), 2603 (5), or CJB111 (5). If the Streptococcus used is S. pneumoniae, then preferably the serotypes selected are one or more, or all of 4, 6B, 9V, 14, 18C, 19F, and 23F. Serotype 1 may also preferably be selected. Preferably the serotypes selected are one or more, or all of 1, 3, 4, 5, 6B, 7F, 9V, 14, 18C, 19F, and 23F.

Moreover, the culture may be homogeneous (i.e. consists of a single species or strain of Streptococcus), or may be heterogeneous (i.e. comprises two or more species or strains of Streptococcus). Preferably the culture is homogeneous.

The Streptococcus used may be a wild type strain or may be genetically modified. For instance, it may be modified to produce non-natural capsular polysaccharides or heterologous polysaccharides or to increase yield.

### Particular Embodiments

Particular embodiments of the invention include: A method of removing protein from a starting solution comprising bacterial capsular polysaccharide (CPS) and bacterial proteins, comprising the steps of:
i. providing a fermentation broth comprising one or more bacterial cells selected from the group consisting of Streptococcus agalactiae serotypes Ia, Ib, II, III, IV, V, VI, VII, VIII and IX;
ii. lysing the bacterial cells from step (a) with a lytic agent, thereby producing a cell lysate comprising cell debris, soluble proteins, nucleic acids and polysaccharides;
iii. Optionally clarifying the cell lysate of step (b) using centrifugation or filtration to remove cell debris, thereby producing a composition contain bacterial capsular polysaccharide (CPS) and bacterial proteins;
a. providing a composition containing bacterial capsular polysaccharide (CPS) and bacterial proteins;
b. contacting said composition with an alcohol solution, and removing any precipitate that forms;
c. maintaining the non-precipitated material from step (b) in solution and filtering the solution to remove smaller molecular weight compounds while retaining the capsular polysaccharide in solution; and
d. collecting the filtrate from step (c) and chromatographically removing protein contaminants from said filtrate, using a polymer resin stationary phase, to provide purified capsular polysaccharide;
e. Optionally re-N-acetylating the purified capsular polysaccharide,
f. Optionally precipitating the purified capsular polysaccharide; and
g. Optionally conjugating the purified capsular polysaccharide to a carrier protein.

### Further Antigenic Components of Compositions of the Invention

The methods of the invention may also comprise the steps of mixing a streptococcal conjugate with one or more additional antigens, including the following other antigens: a saccharide antigen from Haemophilus influenzae B; a purified protein antigen from serogroup B of Neisseria meningitides; an outer membrane preparation from serogroup B of Neisseria meningitides; an antigen from hepatitis A virus, such as inactivated virus; an antigen from hepatitis B virus, such as the surface and/or core, antigens; a diphtheria antigen, such as a diphtheria toxoid; and a tetanus antigen, such as a tetanus toxoid; an antigen from Bordetella pertussis, such as pertussis holotoxin (PT) and filamentous hemagglutinin (FHA) from B. pertussis, optionally also in combination with pertactin and/or agglutinogens 2 and 3; polio antigen(s); measles, mumps and/or rubella antigens; influenza antigen(s) such as the haemagglutinin and/or neuraminidase surface proteins; an antigen from Moraxella catarrhalis; a protein antigen from Streptococcus agalactiae (group B streptococcus); an antigen from Streptococcus pyogenes (group A streptococcus); an antigen from Staphylococcus aureus. Toxic protein antigens may be detoxified where necessary (e.g., detoxification of pertussis toxin by chemical and/or genetic means).

Antigens in the composition will typically be present at a concentration of at least 1 g/ml each. In general, the concentration of any given antigen will be sufficient to elicit an immune response against that antigen in the subject being treated.

### Terms

As used herein, “purification” of bacterial CPS refers to a process of separating, in a composition containing both CPS and non-CPS contaminants, the CPS from the contaminants. Purification as used herein is not synonymous with providing a 100% pure composition of CPS (i.e., removing all contaminants). Non-CPS components (contaminants) such as cellular proteins and nucleic acids are preferentially removed from the starting material to provide a material having an increased percentage of CPS (e.g., increase in MW % of CPS), relative to that of the starting material. Such a method is useful in the production of bacterial capsular polysaccharides, including those from S. agalactiae, following culture and/or fermentation. Such methods are referred to herein as purification, or a purification step.

The term “comprising” encompasses “including” e.g. a composition “comprising” X may include something additional e.g. X+Y. The term, “consisting essentially of” means that the process, method or composition includes additional steps and/or parts that do not materially alter the basic and novel characteristics of the claimed process, method or composition. The term, “consisting of” is generally taken to mean that the invention as claimed is limited to those elements specifically recited in the claim (and may include their equivalents, insofar as the doctrine of equivalents is applicable).

The term “about” in relation to a numerical value x means, for example, x±10%, ±5%, ±4%, ±3%, ±2% or ±1%.

The word “substantially” does not exclude “completely” e.g. a composition which is “substantially free” from Y may be completely free from Y. Where necessary, the word “substantially” may be omitted from the definition of the invention. Where methods refer to process steps these may be performed sequentially, for example (a) followed by (b), followed by (c), followed by (d), followed by (e), etc.

The practice of the present invention will employ, unless otherwise indicated, conventional techniques of molecular biology, microbiology, recombinant DNA, and immunology, which are within the skill of the art. Such techniques are explained fully in the literature. See, e.g., DNA Cloning, Volumes I and II (D. N Glover ed. 1985); Oligonucleotide Synthesis (MT Gait ed, 1984); Nucleic Acid Hybridization (B. D. Hames & ST Higgins eds. 1984); Transcription and Translation (B. D. Hames & ST Higgins eds. 1984); Animal Cell Culture (RI. Freshney ed. 1986); Immobilized Cells and Enzymes (IRL Press, 1986); B. Perbal, A Practical Guide to Molecular Cloning (1984); the Methods in Enzymology series (Academic Press, Inc.), especially volumes 154 & 155; Gene Transfer Vectors for Mammalian Cells (J. H. Miller and M. P. Calos eds. 1987, Cold Spring Harbor Laboratory); Mayer and Walker, eds. (1987), Immunochemical Methods in Cell and Molecular Biology (Academic Press, London); Scopes, (1987) Protein Purification: Principles and Practice, Second Edition (Springer-Verlag, N.Y.), Handbook of Experimental Immunology, Volumes I-IV (D. M. Weir and C. C. Blackwell eds 1986), Remington's Pharmaceutical Sciences, Mack Publishing Company, Easton, Pa., 19th Edition (1995); Methods In Enzymology (S. Colowick and N. Kaplan, eds., Academic Press, Inc.); and Handbook of Experimental Immunology, Vols. I-IV (D. M. Weir and C. C. Blackwell, eds., 1986, Blackwell Scientific Publications); Sambrook, et al., Molecular Cloning: A Laboratory Manual (2nd Edition, 1989); Handbook of Surface and Colloidal Chemistry (Birdi, K. S. ed., CRC Press, 1997); Short Protocols in Molecular Biology, 4th ed. (Ausubel et al. eds., 1999, John Wiley & Sons); Molecular Biology Techniques: An Intensive Laboratory Course, (Ream et al., eds., 1998, Academic Press); PCR (Introduction to Biotechniques Series), 2nd ed. (Newton & Graham eds., 1997, Springer Verlag); and Peters and Dalrymple, Fields Virology (2d ed), Fields et al. (eds.), B. N. Raven Press, New York, N.Y.

Standard abbreviations for nucleotides and amino acids are used in this specification.

All publications, patents, and patent applications cited herein are incorporated in full by reference.

### EXAMPLES

### Example 1: Resins Used in Chromatography

The term chromatography indicates a set of techniques that are designed to separate a mixture into component parts, which can then be assessed for quality and quantity. These techniques are based on the differential distribution of components between two phases, a phase called fixed or stationary phase and the mobile phase or eluent, which flows continuously through the stationary phase. The present studies used resins, as described herein, as the stationary phase.

Using GBS type V capsular polysaccharide, chromatography with different resin matrixes was assessed as an alternative to the use of cationic detergent treatment and/or a carbon filter in the purification of bacterial CPS.

Ten different commercially-available resins (Table 1) were selected from two suppliers: Sigma-Aldrich (St. Louis, Mo., USA; a part of MilliporeSigma) and Purolite Company (Bala Cynwyd, Pa., USA). These resins are described by the manufacturer as suitable for industrial processes and resistant to pH changes.

TABLE 1

| Provider | Tradename | |
|---|---|---|
| Sigma- | AMBERLITE ™ XAD4 | co-polymers of styrene and |
| Aldrich | | divinylbenzene; each bead is a |
| | AMBERLITE ™ XAD16N | conglomeration of microspheres |
| | AMBERLITE ™ XAD1180N | |
| Purolite | PUROSORB ™ PAD350 | Polystyrene; spherical beads |
| | PUROSORB ™ PAD550 | |
| | PUROSORB ™ PAD700 | |
| | PUROSORB ™ PAD910 | |
| | CHROMALITE PCG900M | Cross-linked |
| | CHROMALITE PCG1200M | styrene/divinylbenzene |
| | CHROMALITE 70 MN | |

AMBERLITE AD is a polymer resin. This is a non-ionic, macroreticular polymer that absorbs and releases molecules through hydrophobic interactions in polar or low volatile solvents. The AMBERLITE AD are co-polymers of styrene and divinylbenzene. Each granule (bead) is a conglomeration of microspheres (FIG. 2) that offers an excellent physical and chemical structural stability. Pores allow rapid mass transfer and particle sizes ensure a low pressure during use. The hydrophobic chemical nature makes AMBERLITE™XAD a good adsorbent in reverse phase conditions.

AMBERLITE AD4: polymeric adsorbent for small hydrophobic components, surfactants, phenols, pharmaceuticals.

AMBERLITE AD16N: adsorbent for hydrophobic components of medium size (up to 40000 MW Dalton), such as antibiotics, pharmaceuticals, surfactants, and protein.

AMBERLITE AD1180N: polymeric adsorbent for hydrophobic organic components with relatively high molecular weight.

Principle characteristics of AMBERLITE AD resins are shown in Table 2.

TABLE 2

| | AMBERLITE | AMBERLITE | AMBERLITE |
|---|---|---|---|
| | XAD4 | AD16N | XAD1180N |
| Particle diameter | 560-710 | 560-710 | 350-600 |
| (μm) | | | |
| Pore Size (Å) | 100 | 200 | 300-400 |
| Surface Area (m²/g) | 750 | 800 | 450 |
| Pore volume (mL/g) | 0.98 | 0.55 | 1.4 |

PUROSORB PAD is a synthetic polymer adsorbent with high crosslinking and porosity. These polymers are produced using high purity monomers that are suitable for purifying pharmaceuticals and use in food industries.

PUROSORB PAD350 is a non-ionic polymeric macro-porous adsorbent. This product has a relatively low porosity and therefore offers a large surface area.

PUROSORB PAD50 is a non-ionic polymeric macro-porous adsorbent which has a surface area higher than many other hydrophobic adsorbents while maintaining a good porosity.

PUROSORB PAD700 offers a higher porosity with smaller pores and, as a result, slightly less surface area when compared to similar products. This is achieved through a special polystyrene crosslinked structure. The spherical particles give little back pressure in normal operating flow conditions.

PUROSORB PAD910 has larger pores (1200 Angstroms, (A)) while maintaining the general characteristics of the above PUROSORB resins.

Principle characteristics of PUROSORB resins are shown in Table 3.

TABLE 3

| | PUROSORB | | PUROSORB | | PUROSORB | | PUROSORB | |
|---|---|---|---|---|---|---|---|---|
| | PAD350 | | PAD550 | | PAD700 | | PAD910 | |
| Polymer Structure | Polystyrenic | | Polystyrenic | | Polystyrenic | | Polystyrenic | |
| Appearance | Spherical beads | | Spherical beads | | Spherical beads | | Spherical beads | |
| Functional group | Non-ionic | | Non-ionic | | Non-ionic | | Non-ionic | |
| Ionic form as | None | | None | | None | | None | |
| shipped | | | | | | | | |
| Mositure | 58-64% | | 58-64% | | 56-62% | | 62-68% | |
| retention | | | | | | | | |
| Particle size range | 350-1200 μm | | 350-1200 μm | | 350-1200 μm | | 350-1200 μm | |
| <350 μm (max) | 2% | | 2% | | 2% | | 2% | |
| Uniformity | 1.6 | | 1.6 | | 1.6 | | 1.6 | |
| Coefficient (max) | | | | | | | | |
| Pore Volume | 0.7 | ml/g | 1.1 | ml/g | 1.2 | ml/g | 1.6 | ml/g |
| Surface area | 700 | m²/g | 950 | m²/g | 550 | m²/g | 540 | m²/g |

| | | | | |
|---|---|---|---|---|
| D50, Meso and | 350 | 600 | 700 | 1100 |
| Macropores Å | | | | |
| Specific Gravity | 1.05 | 1.05 | 1.02 | 1.02 |
| Shipping weight | 660-710 g/l | 670-720 g/l | 650-700 g/l | 680-730 g/l |
| (approx.) | | | | |
| pH limits, stability | 0-14 | 0-14 | 0-14 | 0-14 |

The CHROMALITE resins are used primarily for reverse phase chromatography. However, there are also different ‘functionalised’ types for ion exchange. The resin is an adsorbent with highly crosslinked styrene/divinylbenzene particles having macro-pores ranging in size from 10 micron to 200 micron.

Because CHROMALITE resins are stable over a wide pH range, pressure and solvents they can be used for high resolution chromatography to purify biomolecules such as proteins, peptides, oligonucleotides and antibiotics.

TABLE 4

| | Particle | Pore | Surface |
|---|---|---|---|
| CHROMALITE | Size | Size | Area |
| Resin | (μm) | (Å) | (m²/g) |
| PCG900 | 35 | 200-300 | >600 |
| | 75 | | |
| | 120 | | |
| PCG1200 | 15 | 300-500 | >600 |
| | 35 | | |
| | 75 | | |
| | 120 | | |
| MN | 5 | 200-250 | >1200 |
| | 10 | | |
| | 15 | | |

CHROMALITE PCG900M is a macro-porous adsorbent of polydivinylbenzene. The most common adsorbent used as the stationary phase for hydrophobic chromatography is vinylbenzene styrene. Divinylbenzene (DVB) is similar to styrene, and consists of a benzene ring bonded to two vinyl groups, whereas the styrene ring has only one vinyl. The presence of carbon-carbon double bonds makes divinylbenzene very reactive.

### Example 2: Preparation of Capsular Polysaccharide

S. agalactiae type V was grown via fermentative culture. CPS was extracted and the CPS preparation underwent alcoholic precipitation to remove some contaminating proteins and/or nucleic acids.

After the alcoholic precipitation step, the CPS preparation underwent the following: a first 30 kDa Ultrafiltration/Diafiltration (UF/DF) 30 kDa, with buffer exchange (10 mM NaPi, pH 7.2); acid precipitation; and a second 30 kDa UF/DF filtration with buffer exchange (0.3M Carbonate+0.3M NaCl). The resulting preparation was used as to compare the use of several resins in chromatographic purification of CPS

Prior to chromatography, the preparation was dialyzed an additional time, in 50 mm Sodium Phosphate (NaPi) pH8 buffer. This additional ultrafiltration step provided a buffer compatible with the chromatographic experiments. Using 50 mM NaPi pH8 buffer allowed chromatography of polysaccharide under a variety of conditions, as different pH and conductivity could be obtained by adding NaCl and/or diluting with phosphate buffer (1 m Na2HPO4). The resulting preparation was used as the starting material in comparing the use of different resins in chromatographic purification of CPS.

### Example 3: Protocol for Resin Screening

The ten resins listed in TABLE 1 were evaluated. The purification was performed in batch mode by gravity flow using polypropylene conical columns having a height of 9 cm, conical 0.8-0.4 cm. Each type of resin was pre-treated under conditions recommended by the supplier prior to use, as follows.

AMBERLITE XAD: preservative was removed by three cycles of washing with purified water (purified using a MILLI-Q purification system, Millipore Corporation).

For CHROMALITE and PUROSORB resins: after weighing the required amount of resin, it was dissolved in ethanol at 50%. Treatment with ethanol removed contaminants. After incubation overnight (0/N) at a temperature of 2-8° Centigrade (C), ethanol was removed and three cycles of washing was performed with purified water (MILLI-Q purification system, Millipore Corporation).

After column equilibration, 5 ml of CPS-containing starting material was applied at a load density of approximately 7 mg polysaccharide (PS)/ml resin and 0.5 mg total protein (TP)/ml resin. The polysaccharide that is not adsorbed to the resin is eluted, while proteins remain adhered to the resin. After loading/elution one step of washing was performed using 5 ml buffer to retrieve any material remaining in the column, and this fraction was also collected.

Before each chromatographic run, the resin was tapped to give a stable bed and avoid variations in volume, voids or air bubbles.

A column efficiency test assesses the performance of the column before starting purification. The benchmark is the analysis of the distribution and the dwell time of a tracer substance passing through the column. To characterize the chromatographic column without interference, the tracer substance and eluent are selected to avoid chemical interactions with the medium, as well as fluid flow problems.

The efficiency of the column is typically defined in terms of two parameters: the number of theoretical plates (equilibrium stages) and peak asymmetry (the symmetry of the peak).

The magnitude of a peak is typically described by the number of items ‘N’ or by the Height Equivalent of a Theoretical Plate (HETP), representing the equilibrium state of the column. One can imagine that the column is divided into N slices, in each of which a balance is achieved between the stationary and mobile phases. Each of these sections is a theoretical plate. This method involves measuring the peak width at half of the maximum height of the peak. The retention time or retention volume measured at maximum peak height corresponding to the average residence time or volume required to elute the sample from the column.

$$HETP = \frac{L}{N}$$

$$N = 5.54 {( \frac{t}{W \frac{1}{2}} )}^{2}$$

Asymmetry is a dimensionless parameter useful for characterizing efficiency because it is independent of the length of the column and the stationary phase particle diameter. Deviations from an ideal value of symmetry of the peaks can be caused by irregularities in the packaged bed itself. Chromatographic peaks rarely have a Gaussian shape. The deformations that often occur are of two types: Tailing (when the profile rises sharply and quickly reaches the maximum point then descends more slowly towards the baseline) and Fronting (when the profile rises slowly to the point of maximum and descends rapidly towards the baseline peak). (See FIG. 3)

The asymmetry of a peak is expressed by the ratio of asymmetry AS=b/a, wherein ‘a’ is the width of the first half of the peak at 10% of the maximum height and ‘b’ is the width of the second half of the peak at 10% of the maximum height.

The Procedure used for bed integrity of CHROMALITE™PCG900M is summarized in Table 5.

TABLE 5

| Chromatography | | | |
|---|---|---|---|
| Block | Parameters | Detection | Flow |
| Equilibrate | 2.5 CV | Conductivity | 200 |
| | 0.4M NaCl solution | (mS/cm) | cm/h |
| Load | 0.01 CV | | |
| | 2M NaCl solution (tracer) | | |
| Elution | 1.5 CV with 0.4M NaCl | | |
| | solution | | |

System used for analysis: ÄKTA ™ avant 25, Unicorn 6.1 software
CV = Column Volume

The polysaccharide purification protocol for the determination of the range of loading densities to be applied in the purification procedure is outlined in TABLE 6.

TABLE 6

| Chromatography | | | | | |
|---|---|---|---|---|---|
| Block | Volume | Buffer | Outlet | Detection | Flow |
| Equilibrate | 5 CV | Buffer | waste | UV₂₁₅ₙₘ | 150 |
| Load | 90 ml | 50 mM | Fraction | UV₂₈₀ₙₘ | cm/hour |
| Wash | 7 CV | phosphate | 12 ml | Conductivity | |
| | | pH 7.0 | | (mS/cm) | |
| Elution | 10 CV | 50% w/w | | pH | |
| | | DPG | | | |

System used for analysis: ÄKTA ™ avant 25, Unicorn 6.1 software
DPG = dipropylene glycol
mS/cm = milliSiemens/centimeter

TABLE 7
The polysaccharide purification Protocol
for optimization of the step:

| Chromatography | | | | | |
|---|---|---|---|---|---|
| Block | Volume | Buffer | outlet | Detection | Flow |
| Equilibrate | 5 CV | Buffer | waste | UV₂₁₅ₙₘ | variable |
| Load | Volume | variable | Start | UV₂₈₀ₙₘ | according |
| | variable | according to | collecting in | Conductivity | to the |
| | according to | the design | outlet 1 when | (mS/cm) | design |
| | the design | condition | UV₂₁₅ₙₘ > | pH | condition; |
| | condition | | 2 mAU | | 200-600 |
| Wash | 7 | | Stop | | cm/h |
| | | | collecting | | |
| | | | when | | |
| | | | UV₂₁₅ₙₘ < | | |
| | | | 5 mAU or after | | |
| | | | 3 CV from | | |
| | | | beginning of | | |
| | | | the wash | | |
| | | | block | | |

System used for analysis: AKTA ™ avant 25, Unicorn 6.1 software
mAU = milli absorption units

As no studies have been done relating to reuse of the resins, new columns were used each time and used resin was disposed of As was apparent in the preliminary study, the polysaccharide was eluted in the fraction not adsorbed by the resin, while proteins remain adhered to the resin. Therefore, since resin is not re-used, elution/regeneration steps are not included in the experimental protocol.

### Example 4: Technical Analysis

TABLE 8
Analytical panel

| | Process | | |
|---|---|---|---|
| Analytical | Intermediate | | |
| Method | Analyzed | Attribute | Outcomes of DoE |
| micro BCA | Intermediate | Protein | — |
| Assay | to Purify | concentration | |
| GPC | Intermediate | Polysaccharide | Quantity of |
| | to Purify; | Concentration, | polysaccharide |
| | Intermediate | Molecular | (yield of the |
| | purified | Weight of | chromatographic |
| | | polysaccharide | step) Delta |
| | | | Molecular Weight |
| FLR | Intermediate | Protein | Content of Impurities |
| | to Purify; | concentration | |
| | Intermediate | | |
| | purified | | |

The MicroBCA assay is a colorimetric assay for the detection and quantification of total content of proteins in a sample. It is a method which is based on the conversion of Cu²⁺ to Cu¹⁺ under alkaline conditions (Biuret reaction).

Bicinchoninic Acid (BCA) is used for the determination of Cu¹⁺, which forms when Cu²⁺ is reduced by a protein in basic environment. The method spectrophotometrically determines the amount of a purple complex (absorbs 562 nm) produced by the reaction of BCA and ions formed when copper is reduced by proteins in a basic environment.

Absorbance is proportional to the amount of protein present in solution and can be estimated through comparison with a protein standard, such as bovine serum albumin (BSA). The macromolecular structure of a protein, its number of peptide bonds and the presence of four specific amino acids (cysteine, cystine, tryptophan and tyrosine) are responsible for the formation of colour with BCA. This assay can be performed using the Pierce™ BCA Protein Assay Kit (Thermo Fisher Scientific).

### Example 5: Gel Permeation Chromatography (GPC)

In this study the concentration of polysaccharide and its molecular weight in purified intermediates and purified eluates was determined using GPC. This method identifies concentration, molecular weight, and polydispersity of polysaccharide in one analytical session. GPC is a type of molecular exclusion chromatography (SEC=size exclusion chromatography) that separates molecules based on weight and hydrodynamic volume. In GPC, samples are injected into a continuous stream of solvent (mobile phase). When injected, the analytes permeate depending on the size of the pores in the column and according to their hydrodynamic volume (usually related to molecular weight). Smaller molecules enter the pores resulting in a longer retention time. Large molecules are excluded from the pores and are eluted with low retention times (exclusion limit). Intermediate molecules partially permeate the pores and have intermediate retention times. The column separates analytes according to the molecular weight and the molecular weight distribution takes the form of a chromatogram. The detector is typically an Ultraviolet (UV) visible spectroscope, but for samples that do not have UV absorption a refractive index detector is used. The use of standard molecular weight polymers allows the estimation of the molecular weight of the sample.

In the present study, this analytical method is based on the principle of two dimensions (2D for which two chromatographic columns are used (RP-SEC-HPLC)). The first column is a reverse phase (RP) column and removes impurities (proteins, salts, etc.) arising from fermentation. The second column is a Size Exclusion (SE) column that separates polysaccharide molecules based on the hydrodynamic volume. Being a dimensional analysis, using software allows determination of the peak molecular weight (Mp), molecular weight average (Mw), number-average molecular weight (Mn) and their relationship (Mw/Mn), to express the polydispersity of polysaccharide (monodispersed molecules have a value of 1).

To perform the dimensional analysis of GBS polysaccharides with this method, we used a selection of standard GBS polysaccharide fractions at different molecular weights, specific to each serotype, obtained through the collection in fractions of the corresponding GBS polysaccharides, obtained by means of a preparative chromatography by Gel filtration. The standards obtained for each serotype, were aliquoted and frozen (−20° C.). Before use, samples were thawed. The different standard fractions were characterized by SEC-MALLS and average values obtained at the height of the peak (Peak MW, Mp) were taken as reference value for system calibration curve GPC using the Empower 3 software.

### Example 6: GPC Procedure

The columns used were:
RP-Jupiter 5 μm C4 300 Å 250×4.6 mm (PHENOMENEX, Torrance, Calif., USA).
TSKgel PWH 7.5×75 mm (Tosoh Bioscience, King of Prussia, Pa., USA).
SEC-TSKgel G4000SW 7.8 mm ID×300 mm (Tosoh Bioscience, King of Prussia, Pa., USA)

Preparation of reagents and solutions was as follows:

R1 (Mobile phase A): preparation of Mobile phase A (5 litres): 10 mM NaPi, 10 mM NaCl, 5% acetonitrile (CAN), pH 7.2. Weigh and melt: 2.97 g NaH2PO4×H2O; 5.06 g of Na2HPO4×2H2O; 2.92 g NaCl in a final volume of 4750 mL purified water, then add 250 mL of ACN. Filter the resulting solution with Phenex Filter 0.20 μm Membranes 47 mm Nylon (PHENOMENEX) or equivalent.

R2 (mobile phase B) prepare about 2 L of purified water.

R3 (mobile phase C) preparation of 90% CAN.

Measure 900 mL of acetonitrile (ACN) and make up to 1 L with purified water.

R4: preparation of dilution buffer (1 liter) NaPi 100 mM, NaCl 100 mM, TFA 0.1%, ACN 5% at pH 7.2, for samples of material to purify.

For calibration, standards of different molecular weights were used. The preparation was done via preparative chromatography gel filtration, in which a polydispersity of polysaccharides is split. Individual fractions were analysed, from which we determined the various molecular weights. Table 9 shows the fractions with molecular weights (Daltons, Da):

TABLE 9

| Fraction | Mp (Da) |
|---|---|
| 1 | 130500 |
| 2 | 120500 |
| 3 | 112500 |
| 4 | 106500 |
| 5 | 96900 |
| 6 | 79600 |

To determine the polysaccharide, standards of known concentration are used to construct a calibration curve in terms of concentration (TABLE 10):

TABLE 10

| Standard | Concentration μg/ml |
|---|---|
| 1 | 50 |
| 2 | 100 |
| 3 | 250 |
| 4 | 500 |
| 5 | 750 |
| 6 | 1000 |

The analysis is performed with the appropriate sample dilutions of GBS polysaccharide, diluted in R4. Depending on the concentration at each phase of purification, proceed directly to the filtration 0.2 μm in autosampler vials. Inject twice (consecutively or separately) 100 μl of each sample from the same vial.

TABLE 11

| | |
|---|---|
| Instrument | HPLC Waters Alliance W2690/5 or equivalent |
| Software | Empower |
| Equilibration | Wash the RPC column for one hour with 95% R2 and 5% |
| | R3; then condition the column for two hours with R1. |
| | Wash the SEC column for one hour with R2 and then |
| | condition for at least two hours with R1. |
| Eluent | 10 mM NaPi, 10 mM NaCl, 5% ACN, pH 7.2 (R1) |
| Mobile | |
| phase A | |
| Eluent | Purified water (R2) |
| Mobile | |
| phase B | |
| Eluent | ACN 90% (R3) |
| Mobile | |
| phase B | |
| Flow SEC | 0.5 mL/min |
| Flow RP | See Table 12 |
| Injection | 100 μL |
| volume | |
| Time of | 40 minutes |
| Travel | |
| Revelation | UV 210 nm |
| Revelation | 277 nm, 305 nm |
| FLR | |
| Revelation | Sensitivity = 64 |
| RI | |

TABLE 12

| | Eluent | Eluent | Eluent | Eluent | |
|---|---|---|---|---|---|
| Time | A (%) | B (%) | C (%) | D (%) | Flow |
| 0 | 100 | 0 | 0 | 0 | 0.50 |
| 6 | 100 | 0 | 0 | 0 | 0.50 |
| 11 | 0 | 96 | 5 | 0 | 1.00 |
| 20 | 0 | 0 | 100 | 0 | 1.00 |
| 24 | 0 | 0 | 100 | 0 | 1.00 |
| 25 | 0 | 96 | 5 | 0 | 1.00 |
| 30 | 0 | 96 | 5 | 0 | 1.00 |
| 31 | 100 | 0 | 0 | 0 | 1.00 |
| 35 | 100 | 0 | 0 | 0 | 0.50 |

During processing, the GPC software builds a reference curve, using the retention times and the logarithm of the molecular weight fraction of peak standard. The sample is read on the curve and the software determines dimensional values of the outputs in daltons: Mw, Mn and Polidispersity (Mw/Mn). For each GBS polysaccharide the end result is calculated from the average of two replicates. For quantification of the polysaccharide the software constructs a calibration curve of the concentration of the standard and the chromatographic peak area, the software (Empower), allows processing of the data collected and recorded at a later date. For quantification of GBS polysaccharide size, a refractive index detector was used.

### Example 7: FLR

For the determination of impurities present in the polysaccharide a technique was used that excites the samples at a certain wavelength and measures emission. If the analyte concentration is small enough, the intensity of radiation emitted by fluorescence is proportional to the concentration (s=KC). Fluorescence detectors have the advantage of sensitivity. However, not all molecules that absorb emit fluorescence; such molecules can be pre-treated with reagents that result in fluorescent products. In the present study, all the impurities of UV-absorbing interest emitted fluorescence.

TABLE 13

| Points of the | Standard Percentage |
|---|---|
| Curve | (TRPUR%) |
| 1 | 2.5 |
| 2 | 5 |
| 3 | 10 |
| 4 | 25 |
| 5 | 50 |
| 6 | 75 |
| 7 | 100 |

These impurities have a maximum absorption at 330 nm UV, and a fluorescent light aperture to 400 nm. At these wavelengths, the polysaccharide does not absorb or emit which is why the method can be considered specific for impurities. To perform the measurements a fluorometric detector was used.

### Example 8: Protein Content

AMBERLITE XAD1180N and XAD4 resins showed a high efficiency in removing protein impurities (XAD1180N=97% and XAD4=100% removal). AMBERLITE XAD16N showed a 51% removal rate. Findings on PUROSORB PAD910 and PUROSORB PAD700 showed a percentage of 100% and 99% removal, respectively. PUROSORB PAD550 and PAD350 showed 63% and 52%, respectively.

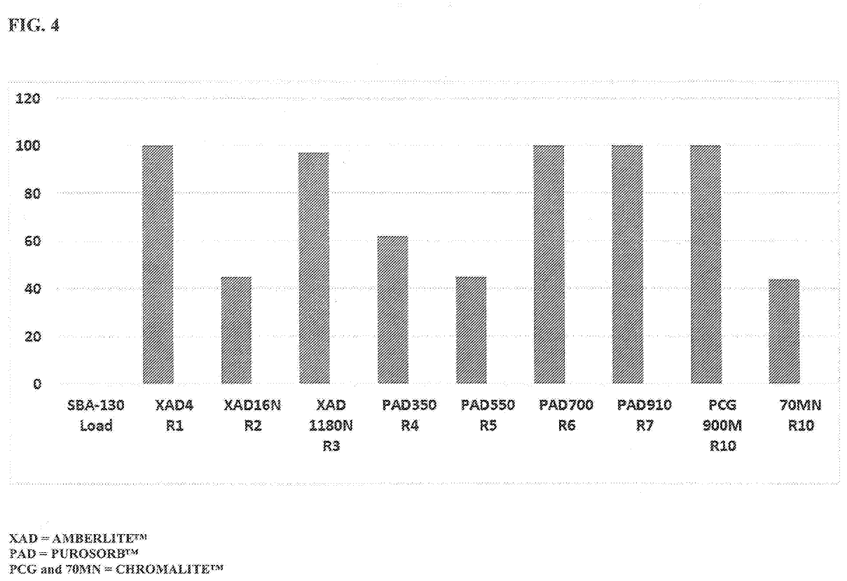

CHROMALITE PCG900 showed 100% protein removal, in contrast to the CHROMALITE 70MN (48%) (see Table 14 and FIG. 4).

TABLE 14

| | | | RP-SEC | MicroBCA | | |
|---|---|---|---|---|---|---|
| | | | PS | Protein | | |
| | | | concentration | Concentration | Ratio | Protein |
| Resin | Sample & | Volume | [RP-SEC] | [MicroBCA] | (mg Protein/ | Removal |
| Code | resin | (ml) | (μg/ml) | (μg/ml) | 1 g PS) | % |
| Load | GBSIa | 5 | 3272 | 454 | 139 | 0 |
| R1 | XAD4 | 5 | 2966 | 2 | 1 | 100 |
| R2 | XAD16N | 5 | 3026 | 221 | 73 | 51 |
| R3 | XAD1180N | 5 | 2951 | 14 | 5 | 97 |
| R4 | PAD350 | 5 | 2941 | 170 | 58 | 63 |
| R5 | PAD550 | 5 | 2950 | 218 | 74 | 52 |
| R6 | PAD700 | 5 | 2538 | <1 | <1 | 100 |
| R7 | PAD910 | 5 | 2813 | 3 | 1 | 99 |
| R8 | PCG900M | 5 | 2806 | <1 | <1 | 100 |
| R10 | 70MN | 5 | 2581 | 235 | 91 | 48 |

AMBERLITE XAD4, PUROSORB PAD700 and CHROMALITE PCG900M resins removed 100% of the protein. The PUROSORB PAD700 and CHROMALITE PCG900 were the only resins that provided an eluate protein content below the lower limit of detection of the BCA assay.

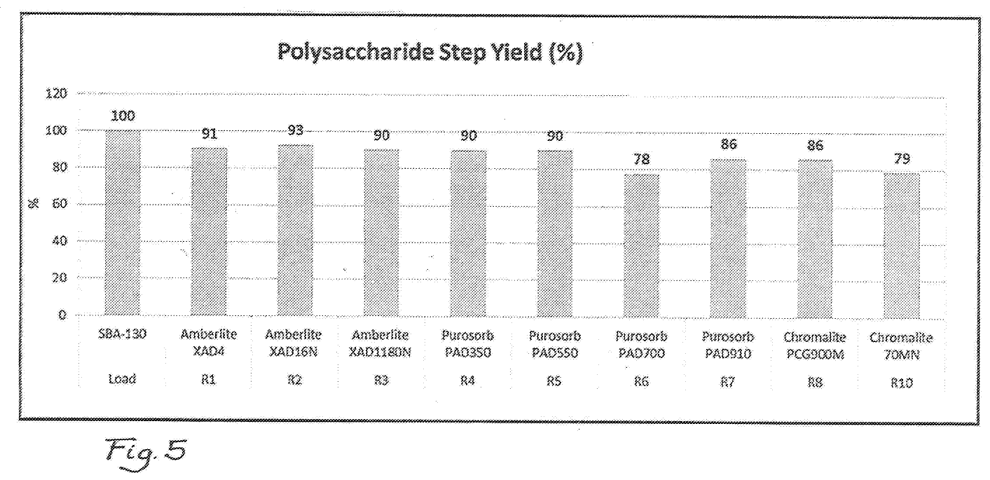

Regarding loss of polysaccharide, AMBERLITE resin showed highest yields (See Table 15 and FIG. 5). (AMBERLITE XAD4=91%, XAD16N=93% XAD1180N=90%). PUROSORB resins PAD350 and PAD550 also achieved 90% yield. The CHROMALITE resins both gave yields of <90%.

TABLE 15

| | | | Analysis RP-SEC | | |
|---|---|---|---|---|---|
| | | | PS | PS | PS |
| | | | concen- | Concen- | Step |
| Resin | Sample & | Volume | tration | tration | Yield |
| Code | resin | (ml) | (μg/ml) | (mg) | (%) |
| Load | GBSIa | 5 | 3272 | 16.36 | 100 |
| R1 | XAD4 | 5 | 2966 | 14.83 | 91 |
| R2 | XAD16N | 5 | 3026 | 15.13 | 93 |
| R3 | XAD1180N | 5 | 2951 | 14.76 | 90 |
| R4 | PAD350 | 5 | 2941 | 14.71 | 90 |
| R5 | PAD550 | 5 | 2950 | 14.75 | 90 |
| R6 | PAD700 | 5 | 2538 | 12.69 | 78 |
| R7 | PAD910 | 5 | 2813 | 14.07 | 86 |
| R8 | PCG900M | 5 | 2806 | 14.03 | 86 |
| R10 | 70MN | 5 | 2581 | 12.91 | 79 |

In contrast, using a carbon filter as described in WO2009081276 (PCT/IB2008/003729) provides lower yields.

Additionally, adherent carbon filters tend to retain polysaccharide molecules with lower molecular weights, thereby leading to an increase of approximately 12 KDa MW in the eluate. AMBERLITE resins did not show such selectivity; the difference in molecular weight between the starting material and the eluate is deemed to be nil or equivalent to the variability of the analytical method (differences from the MW of the starting material less than 1%). The same was observed for PUROSORB and CHROMALITE (see Table 16) with the exception of PUROSORB™ PAD700 (Δ MW=+8780 Da) and CHROMALITE PCG900M (Δ MW=+4528). The effects observed for all resins on polydispersity are to be considered as negligible.

TABLE 16

| | | | GPC | | |
|---|---|---|---|---|---|
| | | | | *Difference | |
| Resin | Sample & | Mn | Mw | (Δ) MW | Poly- |
| Code | resin | (Daltons) | (Daltons) | (Daltons) | dispersity |
| Load | GBSIa | 234805 | 258888 | | 1.18 |
| R1 | XAD4 | 234753 | 259052 | 164 | 1.18 |
| R2 | XAD16N | 234510 | 258776 | −112 | 1.18 |
| R3 | XAD1180N | 235767 | 259623 | 735 | 1.18 |
| R4 | PAD350 | 234730 | 259076 | 188 | 1.18 |
| R5 | PAD550 | 234949 | 259181 | 293 | 1.18 |
| R6 | PAD700 | 245300 | 267668 | 8780 | 1.15 |
| R7 | PAD910 | 234571 | 258797 | −91 | 1.18 |
| R8 | PCG900M | 240888 | 263416 | 4528 | 1.16 |
| R10 | 70MN | 234448 | 258930 | 42 | 1.18 |

*The molecular weight difference was calculated as follows: MW eluate − MW Starting material.

### Example 9: Determination of Loading Range for CHROMALITE PCG900M

CHROMALITE PCG900M was selected as a suitable resin candidate. This resin removed 100% of the proteins with a yield of 86% and a mild effect on the selection of polysaccharide molecules with low molecular weight (difference of MW of 4528 Da). The data obtained were confirmed on polysaccharide serotype V. A chromatographic column (1.0 cm diameter, Height 7.6 cm, Column Volume 6 ml) was prepared with CHROMALITE PCG900M.

Protocol for Packing CHROMALITE PCG900M chromatography column: Weigh a quantity (3 g) of each resin taking into account the CV to be obtained (approximately 3.5 ml). Dissolve the resin in ethanol at 50% (40 ml). After incubation overnight (O/N) at a temperature of 2-8° C., ethanol is removed and the resin washed by three cycles of washing with purified water. Transfer resins into LRC columns (Pall Corporation, Port Washington, N.Y., USA) 20.0 cm×1.0 and rinse using a flow of 20 ml/min using the ÄKTA AVANT 25 preparative chromatography system (GE Healthcare Life Sciences) for one hour. At that point, the piston was lowered in order to have the piston head in contact with the resin bed.

The starting material was prepared according to standard process and dialysed in phosphate buffer pH 7. The material presented the characteristics shown in TABLE 17.

TABLE 17
Starting materials

| | |
|---|---|
| Volume (ml) | 90 |
| Protein [μBCA] μg/ml | 266 |
| Polysaccharide Conc. | 4002 |
| [GPC] (μg/ml) | |
| Total Protein (mg) | 23.9 |
| Total Polysaccharide | 0.36 |
| (mg) | |
| Molecular weight | 127332 |
| [GPC] (Da) | |
| Polydispersity [GPC] | 1.25 |

Starting material (90 ml GBS serotype V) was loaded into the column and the fractionate eluted in seven fractions of 12 ml each, except for the last fraction containing 6 ml.

Chromatographic profiles were obtained with UV 210 nm and UV absorbance at 280 nm. UV absorbance at 280 nm is characteristic of aromatic amino acids while polysaccharides do not absorb significantly at this wavelength, so this test identified the presence of proteins. The polysaccharide is eluted in the fraction and is not absorbed by the column, while most proteins are located in the fraction eluted with DPG (dipropylglycole) as was indicated by the presence of a single UV peak at 280 nm in fractions 1C4-105 (results not shown). Individual fractions (1A1-1B4) were analyzed according to the analytical methods described herein. Results are provided in TABLES 18 and 19.

TABLE 18
Protein

| | | | | Total |
|---|---|---|---|---|
| | | Total | [Protein] | protein |
| fraction | | Volume | (MicroBCA) | content |
| No | name | (ml) | (μg/ml) | (mg) |
| GBS V | 1 A 1 | 90 | 266 | 23.92 |
| F1 | 1 A 2 | 12 | 0 | 0 |
| F2 | 1 A 3 | 12 | 5 | 0.06 |
| F3 | 1 A 4 | 12 | 6.8 | 0.08 |
| F4 | 1 A 5 | 12 | 8.2 | 0.1 |
| F5 | 1 A 6 | 12 | 9.6 | 0.12 |
| F6 | 1 B 1 | 12 | 11.8 | 0.14 |
| F7 | 1 B 2 | 12 | 14 | 0.17 |
| F8 | 1 B 3 | 6 | 10.8 | 0.07 |
| F9 wash | 1 B 4 | 12 | 7.5 | 0.09 |

TABLE 19
Polysaccharide

| | Total | [GBSV] | Total PS |
|---|---|---|---|
| | Volume | (GPC) | content |
| fraction | (ml) | (μg/ml) | (mg) |
| GBS V | 90 | 4002 | 360.18 |
| F1 | 12 | 2781 | 33.37 |
| F2 | 12 | 3351 | 40.21 |
| F3 | 12 | 3920 | 47.04 |
| F4 | 12 | 3929 | 47.15 |
| F5 | 12 | 3938 | 47.26 |
| F6 | 12 | 3970 | 47.63 |
| F7 | 12 | 4001 | 48.01 |
| F8 | 6 | 2738 | 24.21 |
| F-9 wash | 12 | 1474 | 17.69 |

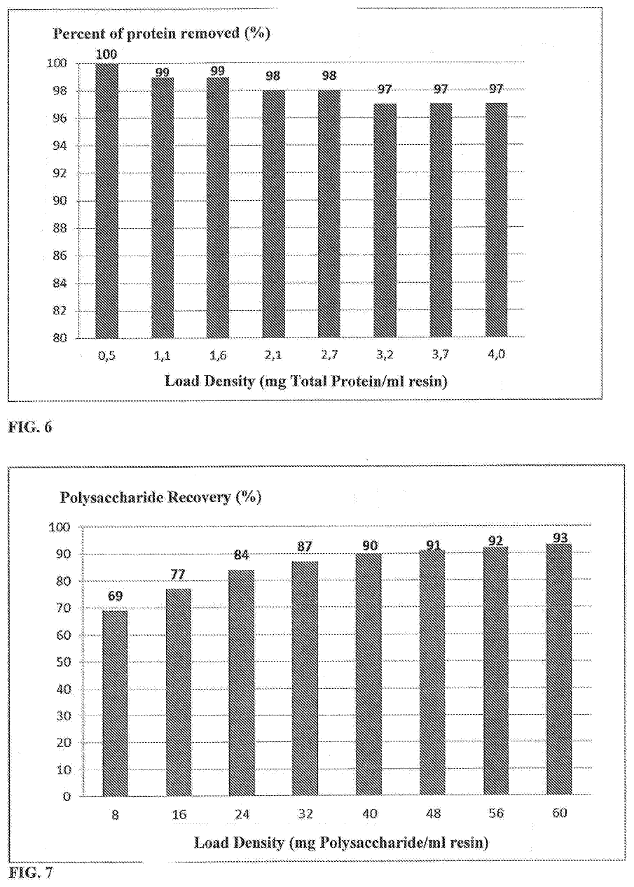

The data obtained and listed in TABLES 18 and 19 were used to determine the different densities applied and their results. In particular, by adding the contents of protein/polysaccharide of each fraction with previous fractions, loading densities were determined. TABLE 20 and FIG. 6 shows the data in terms of protein.

TABLE 20
Protein

| | | | | Loading | | |
|---|---|---|---|---|---|---|
| | | | | Density in | | |
| | | | Protein | Total | Protein | |
| | | | loaded | Protein | Content of | % of |
| Pool | | Total | in | (CV 6 ml) | the Eluted | Protein |
| | Combined | Volume | column | (mg TP/ml | pool | Removed |
| No | Fractions | (ml) | (mg) | resin) | (mg) | (%) |
| 1 | F1 | 12 | 3.19 | 0.5 | 0 | 100 |
| 2 | F1 + F2 | 24 | 6.38 | 1.1 | 0.06 | 100 |
| 3 | F1 − F3 | 36 | 9.57 | 1.6 | 0.14 | 99 |
| 4 | F1 − F4 | 48 | 12.76 | 2.1 | 0.24 | 99 |
| 5 | F1 − F5 | 60 | 15.95 | 2.7 | 0.36 | 98 |
| 6 | F1 − F6 | 72 | 19.14 | 3.2 | 0.5 | 98 |
| 7 | F1 − F7 | 84 | 22.33 | 3.7 | 0.66 | 97 |
| 8 | F1 − F8 | 90 | 23.94 | 4.0 | 0.79 | 97 |

Increasing the loading densities up to 4 mg TP/ml still obtained high values (97%). See TABLE 21 and FIG. 7.

Increasing load density up to 60 mg PS/ml resulted in high values (93%).

TABLE 21
Polysaccharide

| | | | | Loading | | |
|---|---|---|---|---|---|---|
| | | | | Density in | | |
| | | | | Total PS | PS Content | |
| Pool | | Total | PS loaded | (CV 6 ml) | of eluded | |
| | Combined | Volume | in column | (mg PS/ml | pool | % PS |
| No | Fractions | (ml) | (mg) | resin) | (mg) | (%) |
| 1 | F1 | 12 | 48.02 | 8 | 33 | 69 |
| 2 | F1 + F2 | 24 | 96.05 | 16 | 74 | 77 |
| 3 | F1 − F3 | 36 | 144.07 | 24 | 121 | 84 |
| 4 | F1 − F4 | 48 | 192.1 | 32 | 168 | 87 |
| 5 | F1 − F5 | 60 | 240.12 | 40 | 215 | 90 |
| 6 | F1 − F6 | 72 | 288.14 | 48 | 263 | 91 |
| 7 | F1 − F7 | 84 | 336.17 | 56 | 311 | 92 |
| 8 | F1 − F8 | 90 | 360.38 | 60 | 335 | 93 |

### ADDITIONAL REFERENCES

1. Ada & Isaacs (2003) Clin Microbiol Infect 9:79-85.
2. Shen et al. (2001) Vaccine 19:850-61.
3. Palazzi et al. (2004) J. Infect. Dis. 190:558-64.
4. Merritt et al. (2000) J. Biotech. 81:189-97.
5. Dassy & Fournier (1996) Infect. Immunol. 64:2408-14.
6. Suarez et al. (2001) Appl. Env. Microbiol. 67:969-71.
7. Wicken et al. (1983) J. Bact. 153:84-92.
8. W098/32873.
9. Frash (1990) p. 123-145 of Advances in Biotechnological Processes vol. 13 (eds. Mizrahi & Van Wezel).
10. EP 0072513.
11. UK 0502096.1 (patent application); WO2006/082527.
12. U.S. Pat. No. 6,248,570.
13. Deng et al. (2000) J. Biol. Chem. 275:7497-7504.
14. Inzana (1987) Infect. Immun. 55:1573-79.
15. Ramsay et al. (2001) Lancet 357(9251):195-96.
16. Lindberg (1999) Vaccine 17 Suppl. 2:S28-36.
17. Buttery & Moxon (2000) J R Coll Physicians Land 34:163-68.
18. Ahmad & Chapnick (1999) Infect. Dis. Clin. North Am. 13:113-33, vii.
19. Goldblatt (1998) J. Med. Microbiol. 47:563-7.
20. EP 0477508.
21. U.S. Pat. No. 5,306,492.
22. WO98/42721.
23. Dick et al. in Conjugate Vaccines (eds. Cruse et al.) Karger, Basel, 1989, 10:48-114.
24. Hermanson Bioconjugate Techniques, Academic Press, San Diego (1996) ISBN: 0123423368.
25. EP 0372501A.
26. EP 0378881A.
27. EP 0427347A.
28. WO93/17712.
29. WO94/03208.
30. WO98/58668.
31. EP 0471177A.
32. WO91/01146.
33. Falugi et al. (2001) Eur. J. Immunol. 31:3816-24.
34. Baraldo et al. (2004) Infect. Immun. 72:4884-87.
35. EP 0594610 Å.
36. WO00/56360.
37. WO02/091998.
38. Kuo et al. (1995) Infect. Immun. 63:2706-13.
39. WO01/72337.
40. WO00/61761.
41. WO04/041157.
42. WO99/42130.
43. WO04/011027.
44. Lees et al. (1996) Vaccine 14:190-98.
45. WO95/08348.
46. U.S. Pat. No. 4,882,317.
47. U.S. Pat. No. 4,695,624.
48. Porro et al. (1985) Mol. Immunol. 22:907-19.
49. EP 0208375 Å.
50. WO00/10599.
51. Geyer et al. Med. Microbiol. Immunol., 165:171-288 (1979).
52. U.S. Pat. No. 4,057,685.
53. U.S. Pat. Nos. 4,673,574; 4,761,283; 4,808,700.
54. U.S. Pat. No. 4,459,286.
55. U.S. Pat. No. 4,965,338.
56. U.S. Pat. No. 4,663,160.
57. U.S. Pat. No. 4,761,283.
58. U.S. Pat. No. 4,356,170.
59. Lei et al. (2000) Dev. Biol. (Basel) 103:259-64.
60. WO00/38711; U.S. Pat. No. 6,146,902.
61. Wessels et al. (1998) Infect. Immun. 66:2186-92.
62. Lamb et al. (2000) Dev. Biol. (Basel) 103:251-58.
63. Lamb et al. (2000) Journal of Chromatography A 894:311-18.
64. D'Ambra et al. (2000) Dev. Biol. (Basel) 103:241-42.
65. Gennaro (2000) Remington: The Science and Practice of Pharmacy. 20th edition, ISBN: 0683306472.
66. Vaccine Design. (1995) eds. Powell & Newman. ISBN: 030644867X. Plenum.
67. WO90/14837.
68. Niikura et al. (2002) Virology 293:273-80.
69. Lenz et al. (2001) J. Immunol. 166:5346-55.
70. Pinto et al. (2003) J. Infect. Dis. 188:327-38.
71. Gerber et al. (2001) Virology 75:4752-60.
72. WO03/024480.
73. WO03/024481.
74. Gluck et al. (2002) Vaccine 20:B10-B16.
75. Johnson et al. (1999) Bioorg. Med. Chem. Lett. 9:2273-78.
76. Evans et al. (2003) Expert Rev. Vaccines 2:219-29.
77. Meraldi et al. (2003) Vaccine 21:2485-91.
78. Pajak et al. (2003) Vaccine 21:836-42.
79. WO2016/020413

1. A method of removing protein from a starting solution comprising bacterial capsular polysaccharide (CPS) and bacterial proteins, comprising a step of filtering said starting solution using chromatography to provide an eluate, where said chromatography utilizes a stationary chromatography phase, and said stationary phase is a particulate polymer resin.

2. (canceled)

3. The method of claim 1, wherein the particulate polymer resin is in the form of spherical particles, and the polymer resin is made from polystyrene, polydivinylbenzene, copolymers of divinylbenzene and styrene, or cross-linked styrene and divinylbenzene.

4. The method of claim 1, wherein the polymer resin has one or more of the following characteristics:
(a) the diameter of a representative sample of said spherical particles ranges from about 300 μm to about 1500 μm, about 500 μm-about 750 μm, about 560 μm-about 710 μm, about 350-about 600 μm, or about 350 μm-about 1200 μm;
(b) non-ionic;
(c) stable of a range of pH values from 0-14, 0-12, 1-14, 1-12, 2-14, or 2-12;
(d) contains pores with an average diameter of about 100 Angstrom (Å), about 200 Å, about 350 Å, about 600 Å, about 700 Å, or about 1100 Å,
(e) contains pores with a range of diameters, ranging from about 200 Å-about 250 Å, about 200 Å-about 300 Å, about 300 Å-about 400 Å, or about 300 Å-about 500 Å; and
(f) contains macro-pores ranging in diameter from about 10 microns to about 200 microns.

5. The method of claim 1, where the polymer resin is in the form of spherical particles made of cross-linked styrene and divinylbenzene and having a range of diameters between about 35-about 120 μm and a range of pore size between about 200-about 300 Å.

6. The method of claim 1, where at least 50%, 60%, 70%, 80%, 85%, 87%, 90%, 91%, 92%, 93%, 94%, 95%, 96%, 97%, 98%, 99%, 99.2%, 99.5%, 99.9% or 100% of the protein is removed from the starting solution by said chromatography.

7. The method of claim 1, where at least 50%, 60%, 70%, 80%, 85%, 87%, 90%, 91%, 92%, 93%, 94%, 95%, 96%, 97%, 98%, 99% or 100% of the CPS in the starting solution is retained in the eluate after chromatography.

8. The method of claim 1 wherein the step of filtering the starting solution using chromatography, in which the stationary chromatography phase is a particulate polymer resin, results in removal of at least 90% of the protein present in the starting solution, while retaining at least 80%, 83%, 85%, 90%, 91%, 92%, 93%, 94%, or 95% of the CPS present in the starting solution.

9. The method of claim 1, wherein the difference in the molecular weight distribution of the CPS in the starting solution and the molecular weight distribution of the CPS in the eluate is less than about 10%, less than about 8%, less than about 5%, less than about 3%, less than about 2%, or less than about 1%.

10. The method of claim 1, wherein the starting solution comprises a buffer at about pH 8.

11. The method of claim 1, wherein the step of filtering the starting solution using chromatography is started at a protein load density of from about 0.5-about 4.0 mg Total Protein (TP) per milliliter of particulate resin.

12. The method of claim 1, wherein the step of filtering the starting solution using chromatography is started at a CPS load density of from about 40-about 60 mg Total Polysaccharide per milliliter of particulate resin.

13. (canceled)

14. The method of claim 1, wherein chromatography is preceded by the steps of:
(a) alcohol precipitation of contaminating proteins and/or nucleic acids; and
(b) diafiltration.

15. The method of claim 1, wherein chromatography is followed by the steps of:
(a) re-N-acetylation; and
(b) diafiltration.

16. The method of claim 1, comprising
(a) providing a composition containing bacterial capsular polysaccharide (CPS) and bacterial proteins;
(b) contacting said composition with an alcohol solution, and removing any precipitate that forms;
(c) maintaining the non-precipitated material from step (b) in solution and filtering the solution to remove smaller molecular weight compounds while retaining the capsular polysaccharide in solution; and
(d) collecting the filtrate from step (c) and chromatographically removing protein contaminants from said filtrate, using a polymer resin stationary phase, to provide purified capsular polysaccharide.

17. The method of claim 16 further comprising one or more of steps:
(e) re-N-acetylating the purified capsular polysaccharide,
(f) precipitating the purified capsular polysaccharide; and
(g) conjugating the purified capsular polysaccharide to a carrier protein.

18. The method of claim 16 wherein step (b) comprises addition of an alcohol solution to a concentration sufficient to precipitate nucleic acid contaminants but not the capsular polysaccharide.

19. The method of claim 18 where said alcohol solution is selected from:
(a) an alcohol solution comprising ethanol; and
(b) an alcohol solution comprising ethanol and CaCl₂.

20. The method of claim 18 where said alcohol solution is added to a concentration of between about 10% and about 50% ethanol, such as about 30% ethanol.

21. The method of claim 16 where said bacterial capsular polysaccharide is a Streptococcus agalactiae CPS.

22. The method of claim 21 where said Streptococcus agalactiae CPS is selected from serotypes Ia Ib, II, III, IV, and V.
